(19) United States
(12) Patent Application Publication
(10) Pub. No.: US 2015/0336066 A1
(43) Pub. Date: Nov. 26, 2015

(54) METHOD OF ENCAPSULATION AND IMMOBILIZATION

(71) Applicants: Lu-Kwang Ju, Akron, OH (US); Uchechukwu Anozie, Akron, OH (US)

(72) Inventors: Lu-Kwang Ju, Akron, OH (US); Uchechukwu Anozie, Akron, OH (US)

(21) Appl. No.: 14/819,822

(22) Filed: Aug. 6, 2015

Related U.S. Application Data
(62) Division of application No. 14/125,748, filed on Dec. 12, 2013.
(60) Provisional application No. 61/502,574, filed on Jun. 29, 2011.

(51) Int. Cl. B01J 13/18; B01J 13/20

(52) U.S. Cl. CPC B01J 13/18; B01J 13/206

(57) ABSTRACT

A method for encapsulating a material, the steps include choosing a material to encapsulate; placing the material into a material solvent to form a material solution; forming a primary emulsion of the material solution in an immiscible liquid medium that is immiscible with the material solvent, wherein the material solution is the disperse phase and the immiscible liquid medium is the continuous phase of the primary emulsion, wherein the immiscible liquid medium contains an encapsulating agent dissolved therein, the encapsulating agent capable of being crosslinked, polymerized, gelled, hardened or solidified; adding the primary emulsion as droplets into a crosslinking medium, wherein the crosslinking medium is immiscible with the continuous phase immiscible liquid medium of the primary emulsion, and thereafter activating the crosslinking, polymerizing, gelling, hardening or solidifying of the encapsulating agent to envelope the material in a crosslinked, polymerized, gelled, hardened or solidified matrix forming the droplets into beads.

### CROSS REFERENCE TO RELATED APPLICATIONS

This application is a divisional of U.S. patent application Ser. No. 14/125,748, filed on Dec. 12, 2013, which claims priority from U.S. Provisional Patent Application No. 61/502,574, filed Jun. 29, 2011, both of which are incorporated herein by reference in their entirety.

### FIELD OF THE INVENTION

The present invention generally relates to the method for the encapsulation and immobilization of various compounds. In one embodiment, the compound that is encapsulated is sulfur, and the main polymer used for encapsulating the sulfur is alginate.

### BACKGROUND OF THE INVENTION

In the manufacturing of tires and other rubber products, sulfur is used in the vulcanization process where crosslinks are formed from the chemical reaction of sulfur and the rubber hydrocarbon double bonds. This vulcanization process varies depending on the recipe used and process conditions. Common sulfur, which is predominantly rhombic sulfur, has limited temperature-dependent solubility in natural rubber and synthetic elastomers. In most cases, the amounts of sulfur required for rubber/elastomer processing, which takes place at high temperatures, are greater than the room temperature solubility of sulfur in the products. Therefore, upon cooling, the excess sulfur would migrate and crystallize on the surface, a phenomenon known as sulfur “blooming” Sulfur blooming negatively affects product quality by decreasing the tackiness and stability of the rubber goods.

The use of polymeric sulfur has been found to increase the resistance to sulfur blooming The polymeric sulfur is termed “insoluble sulfur” because it is insoluble in organic media, natural and synthetic rubber and carbon disulfide (CS₂), while the common non-polymeric sulfur is termed “soluble sulfur”. Insoluble sulfur does not bloom as long as the pre-curing mixing temperature is kept below 120° C. Above 120° C. the insoluble sulfur degrades into soluble sulfur because it is dispersed in rubber as discreet particles that cannot readily diffuse/migrate to the surface.

Processes for producing insoluble sulfur are known in the art and have been developed and commercialized. Unfortunately, due to the process complexity or relatively low product yields, insoluble sulfur is very expensive, as compared to common sulfur. It is desirable to find a more economic alternative to produce insoluble sulfur.

One approach is to use common sulfur in a finely immobilized or encapsulated form. This allows the sulfur to function at the processing conditions, but prevents or minimizes sulfur blooming The microcapsules also help stop the migration of sulfur to the surface of the rubber. Keeping sulfur inactive by encapsulation may also prevent premature crosslinking. There have been some recent efforts in pursuing this approach. For example, sulfur microcapsules have been obtained by interfacial polymerization by the following procedures: (1) prepare a water solution of a dispersing agent and an emulsifying agent, then heat and stir said solution, (2) prepare an oil phase by mixing sulfur and toluene diisocyanate in a separate container, (3) slowly add the oil phase to the water phase under intensive mixing to obtain an oil-in-water (O/W) emulsion, (4) transfer the emulsion into a four-neck flask equipped with a condensation and reflux water device, (5) add with a constant pressure dropping funnel, a water solution of ethylenediamine and diethylenetriamine into the emulsion while stirring, while also maintaining the reaction temperature at 55° C. and the pH at 3-4 with formic acid. After the addition of reactive amines to the continuous water phase; a polyurea wall will form at the interface of the oil droplets, i.e. the dispersed droplets of sulfur and toluene diisocyanate, and the water. Following the formation of the initial shell wall, the reactive amines have to diffuse across the growing shell into the oil phase to react with the toluene diisocyanate in the inner core. Finally, after reacting for 6 hours, the system is cooled to room temperature, followed by a series of post-reaction treatments including vacuum filtration, vacuum drying, water wash, and the removal of the uncoated sulfur with trichloromethane, to get the final microcapsule product.

Urea-formaldehyde resins have also been used to develop a sulfur microcapsule product for rubber vulcanization. The first step of the preparation comprises adding formaldehyde and urea into a flask then adding drops of triethanolamine to obtain a pH value of 8-9, this step takes place at 70° C. while stirring for 1 hour to form a urea-formaldehyde resin prepolymer by an addition reaction at basic conditions. The second step involves the preparation of a water solution containing a macromolecular dispersant and surfactant while stirring under heat. The third step is adding and dispersing, while stirring, sulfur in the above water solution. The fourth step involves adding the sulfur suspension and the urea-formaldehyde resin prepolymer prepared in the first step into a flask, then stirring the mixture and allowing it to react by condensation polymerization for 1 hour at 35° C. and at a pH of from 2.5-4.5, the pH being controlled by an automatic addition of formic acid. The acidic pH condition of the emulsion is the factor that aids in the reaction of formaldehyde with urea at the interface of the emulsion droplets that give rise to the urea-formaldehyde microcapsule polymer shell. The fifth step involves heating and curing the urea-formaldehyde resin at a temperature of from 40-70° C. for 2 hours. The final step is to cool the system to room temperature, filter the system, wash the system, dry the system, and remove the uncoated sulfur with trichloromethane to obtain the sulfur microcapsule.

Melamine-formaldehyde resins have also previously been used for sulfur microencapsulation. The melamine-formaldehyde preparation is similar to the above-mentioned urea-formaldehyde preparation. As an example, the melamine-formaldehyde prepolymer is prepared in the presence of citric acid, instead of triethanolamine, and then the sulfur, citric acid and melamine-resin are thoroughly mixed in water using a dispersion apparatus and high performance agitation. The temperature of the agitated tank is maintained at 60° C. before the wall formation is stopped after 10 minutes, followed by the post-condensation and curing process in a low-shearing agitator for another 120 minutes. These processes are however complicated and harder to control. The microencapsulated sulfur produced by these processes are likely expensive to produce. Therefore, there is a need in the art for a simple and effective method of microencapsulation and immobilization.

### SUMMARY OF THE INVENTION

Embodiment 1: An embodiment of this invention provides a method for encapsulating a material comprising the steps of: (a) choosing a material to encapsulate, (b) placing the material into a material solvent to form a material solution, (c) forming a primary emulsion of the material solution in an immiscible liquid medium that is immiscible with the material solvent, the material solution serving as the disperse phase and the immiscible liquid medium serving as the continuous phase of the primary emulsion, wherein the immiscible liquid medium contains an encapsulating agent dissolved therein, the encapsulating agent being capable of being crosslinked, polymerized, gelled or otherwise hardened or solidified; (d) adding the primary emulsion as droplets into a crosslinking medium, and thereafter (e) activating the crosslinking, polymerizing, gelling, hardening or solidifying of the encapsulating agent to envelope the material in a crosslinked matrix forming the droplets into beads.

Embodiment 2: In another embodiment, this invention provides a method as in Embodiment 1, wherein the crosslinking medium is miscible with the continuous phase immiscible liquid medium of the primary emulsion.

Embodiment 3: In another embodiment, this invention provides a method as in either Embodiment 1 or 2, wherein the crosslinking medium includes an activator that, upon contact with the encapsulating agent, causes the crosslinking, polymerizing, gelling, hardening or solidifying of the encapsulating agent, and wherein said step of activating includes contact between the activator and the encapsulating agent.

Embodiment 4: In another embodiment, this invention provides a method as in any of Embodiments 1-3, wherein the encapsulating agent is capable of being crosslinked, polymerized, gelled or otherwise hardened or solidified by ultraviolet light, and said step of activating includes applying ultraviolet light to the crosslinking medium during or after said step of adding the primary emulsion as droplets into the crosslinking medium.

Embodiment 5: In another embodiment, this invention provides a method as in any of Embodiments 1-4, wherein the encapsulating agent is capable of being crosslinked, polymerized, gelled or otherwise hardened or solidified by heat, and said step of activating includes applying heat to the crosslinking medium during or after said step of adding the primary emulsion as droplets into the crosslinking medium

Embodiment 6: In another embodiment, this invention provides a method as in any of Embodiments 1-5, wherein the crosslinking medium is immiscible with the continuous phase immiscible liquid medium of the primary emulsion.

Embodiment 7: In another embodiment, this invention provides a method as in any of Embodiments 1-6, wherein the primary emulsion is emulsified in said crosslinking medium to create a secondary emulsion.

Embodiment 8: In another embodiment, this invention provides a method as in any of Embodiments 1-7, wherein the crosslinking medium includes an activator that, upon contact with the encapsulating agent, causes the crosslinking, polymerizing, gelling or otherwise hardening or solidifying of the encapsulating agent, and wherein said step of activating includes contact between the activator and the encapsulating agent.

Embodiment 9: In another embodiment, this invention provides a method as in any of Embodiments 1-8, wherein the encapsulating agent is capable of being crosslinked, polymerized, gelled or otherwise hardened or solidified by ultraviolet light, and said step of activating includes applying ultraviolet light to the crosslinking medium during or after said step of adding the primary emulsion as droplets into the crosslinking medium.

Embodiment 10: In another embodiment, this invention provides a method as in any of Embodiments 1-9, wherein the encapsulating agent is capable of being crosslinked, polymerized, gelled or otherwise hardened or solidified by heat, and said step of activating includes applying heat to the crosslinking medium during or after said step of adding the primary emulsion as droplets into the crosslinking medium.

Embodiment 11: In another embodiment, this invention provides a method as in any of Embodiments 1-10, wherein the continuous phase immiscible liquid medium of the primary emulsion includes an activator for activating the crosslinking, polymerizing, gelling or otherwise hardening or solidifying of the encapsulating agent, said activator remaining inert until made active during said step of activating by the use of an initiator.

Embodiment 12: In another embodiment, this invention provides a method as in any of Embodiments 1-11, wherein said material to encapsulate is sulfur.

Embodiment 13: In another embodiment, this invention provides a method as in any of Embodiments 1-12, in which the solvent is selected from the group consisting of methylene iodide, butanol, chloroform, carbon tetrachloride, tetrahydrofuran, carbon disulfide and combinations of the above.

Embodiment 14: In another embodiment, this invention provides a method as in any of Embodiments 1-13, in which the solvent is carbon disulfide.

Embodiment 15: In another embodiment, this invention provides a method as in any of Embodiments 1-14, in which the immiscible liquid medium is selected from the group consisting of ethanol, methanol, acetone, water, and combinations of the above.

Embodiment 16: In another embodiment, this invention provides a method as in any of Embodiments 1-15, in which the immiscible liquid medium water.

Embodiment 17: In another embodiment, this invention provides a method as in any of Embodiments 1-16, wherein said step of forming a primary emulsion includes the use of surfactants selected from the group consisting of cationic, anionic and nonionic surfactants.

Embodiment 18: In another embodiment, this invention provides a method as in any of Embodiments 1-17, wherein the surfactant is a cationic surfactant and is selected from the group consisting of dodecyltrimethylammonium bromide, dodecyltrimetylammonium chloride, cetyltrimethylammonium bromide, tetradecyltrimethylammonium bromide, lauric arginate, laurylmethyl gluceth-10 hydroxypropyldimonium chloride, benzethonium chloride, tetramethylammonium hydroxide, hexadecyltrimethylammonium bromide and hexadecyltrimethylammonium chloride.

Embodiment 19: In another embodiment, this invention provides a method as in any of Embodiments 1-18, wherein the surfactant is a anionic surfactant and is selected from the group consisting of sodium dodecyl sulfate, sodium dodecylbenzenesulfonate, ammonium dodecyl sulfate, potassium dodecyl sulfate, sodium decanoate, sodium dodecanoate, dioctyl sodium sulfosuccinate, sodium stearate, sodium pareth sulfate and sodium myreth sulfate.

Embodiment 20: In another embodiment, this invention provides a method as in any of Embodiments 1-19, wherein the surfactant is a nonionic surfactant and is selected from the group consisting of PEG-80 sorbitan laurate, Laureth-23, Ceteth-20, Oleth-20, polysorbate 20, polysorbate 80, steareth-20, steareth-21, steareth-100 and cetomacrogrol 1000.

Embodiment 21: In another embodiment, this invention provides a method as in any of Embodiments 1-20, in which the surfactants are sorbitan monooleate and polyoxyethylene sorbitan monooleate.

Embodiment 22: In another embodiment, this invention provides a method as in any of Embodiments 1-21, in which the encapsulating agent is selected from the group consisting of proteins, polyethylene glycols, polyamines, chitosan, cellulose acetate with various extents of acetylation, and polysaccharides such as xantham gum, agar, agarose, gelatin, pectin, xylan, pollulan, hemicellulose and alginate and combinations of the above.

Embodiment 23: In another embodiment, this invention provides a method as in any of Embodiments 1-22, in which the encapsulating agent is alginate.

Embodiment 24: In another embodiment, this invention provides a method as in any of Embodiments 1-23, in which the crosslinking medium is water and includes a multivalent cation selected from the group consisting of calcium, iron (Fe3+ and Fe2+), barium, magnesium, aluminum, copper, and cobalt.

Embodiment 25: In another embodiment, this invention provides a method as in any of Embodiments 1-24, in which the crosslinking medium is water and includes water and a multivalent cation in the form of calcium chloride.

Embodiment 26: In another embodiment, this invention provides a microcapsule comprising sulfur encapsulated in a crosslinked, polymerized, gelled or otherwise hardened or solidified matrix of alginate.

Embodiment 27: In another embodiment, this invention provides a method as in Embodiment 26, further comprising a modifier.

Embodiment 28: In another embodiment, this invention provides a method as in any of Embodiments 1-27, wherein the modifier is selected from the group consisting of polymers, crosslinking initiators, thickeners, suspending agents, antioxidants, catalysts, accelerator and other additives for rubber processing, activated carbon, solid or polymeric adsorbents of particular groups of materials, affinity agents to target the binding of microcapsules to particular materials, cells or tissues, clay, carbon black, colorants or any combination of the above.

Embodiment 29: In another embodiment, this invention provides a method as in any of Embodiments 1-28, wherein the modifier is polyethyleneimine.

### BRIEF DESCRIPTION OF THE DRAWINGS

FIG. 1 is a calibration curve of sulfur at a wavelength of 382 nanometers.

### DETAILED DESCRIPTION OF ILLUSTRATIVE EMBODIMENTS

The present invention provides a simple and effective microencapsulation method. First, the material to be encapsulated is chosen. In a particular embodiment, the material to be encapsulated is sulfur, but those of ordinary skill in the art will readily appreciate how to apply the present invention to other materials.

Next, the material to be encapsulated, herein M_{E}, is dissolved in an appropriate solvent to form a solution that is herein termed an M_{E} solution, standing for “a solution of the material to be encapsulated.” The solvent will be chosen based on its ability to dissolve the chosen M_{E} and may be referred to herein as an “M_{E} solvent.”

After dissolving the chosen M_{E} and forming the M_{E} solution, the M_{E} solution is emulsified by placing it in an immiscible liquid medium, by which it is meant that it is placed in a liquid medium that is immiscible, or not completely miscible, with the solvent of the M_{E} solution. In particular embodiments, the immiscible liquid medium is not completely miscible, and, in other embodiments it is immiscible; however, unless specifically stated, it is to be understood that the term “immiscible liquid medium” covers liquid mediums that are not completely miscible, as well as liquid mediums that are immiscible. The M_{E} solution is placed in the immiscible liquid medium along with an appropriate surfactant package to create a primary emulsion, as will be described more fully below. The immiscible liquid medium also includes an encapsulating agent, which will also be described more fully below. These components may be mixed in various orders. For example, the surfactant package and encapsulating agent may be present in the immiscible liquid medium before addition of the M_{E} solution, or may be added thereafter. Suitable agitation or other known measures are taken to emulsify the resultant mixture.

The term “surfactant package” is employed to connote that more than one surfactant might be employed, though the term is to be interpreted as covering the use of a single surfactant. The surfactant package will be chosen for its ability to stabilize the emulsion, as generally known, preventing it from progressively separating. Thus, just as an appropriate solvent may be chosen for dissolving a desired M_{E}, an appropriate immiscible liquid medium and surfactant package can be chosen based upon the solvent of the M_{E} solution.

As will be appreciated more fully herein below, the encapsulating agent ultimately serves to encapsulate or assist with the encapsulation of the chosen M_{E}. Thus the selection of an encapsulating agent is made with this intent in mind, and those of ordinary skill in the art will be able to select an appropriate encapsulating agent for a given system—i.e., for a given M_{E}, M_{E} solution, immiscible liquid medium and other considerations, which, again, will be more apparent after the remainder of this disclosure. The encapsulating agent is chosen to be soluble in the immiscible liquid medium. The encapsulating agents herein are capable of being crosslinked, polymerized, gelled, or otherwise hardened or solidifed to encapsulate the M_{E} and thereby envelope the M_{E} in a crosslinked matrix.

The emulsion formed according to the forgoing disclosure will result in a disperse phase of the M_{E} solution in a continuous phase of the immiscible liquid. This emulsion will be termed herein a “primary emulsion” because, in certain embodiments, it is possible to practice this invention by creating a subsequent emulsion that will be termed herein a “secondary emulsion” and the terms “primary” and “secondary” will help distinguish the two. As mentioned, the immiscible liquid contains the encapsulating agent dissolved therein.

Certain modifiers may be added to the continuous phase of the primary emulsion, depending on the desired attributes of the final encapsulated products. In some embodiments the modifier is selected from the group consisting of polymers, crosslinking initiators, thickeners, suspending agents, antioxidants, catalysts, accelerator and other additives for rubber processing, activated carbon, solid or polymeric adsorbents of particular groups of materials, affinity agents to target the binding of microcapsules to particular materials, cells or tissues, clay, carbon black, colorants or any combination of the above. If the selected modifier is not soluble, then it will be finely divided and suspended in the continuous phase of the primary emulsion. The selected modifier may or may not interact in the actual crosslinking. For example, particular polymers might be chosen to participate in the crosslinking.

In some embodiments, the primary emulsion is a “fine” emulsion. A “fine” emulsion can be defined as one in which the dispersed phase is emulsified/dispersed in the continuous phase as droplets/particles with the average dimensions not larger that 2 millimeters, in other embodiments, not larger than 0.5 millimeters, and, in other embodiments, not larger than 0.1 millimeters. In other embodiments, the fine emulsion is fine and stable emulsion, wherein being “stable” can be defined as an emulsion in which the droplets/particles of the dispersed phase will remain dispersed in the continuous phase and will not coalesce to larger than 1 centimeter in a largest dimension (with the understanding that such coalesced structures can be amorphous, such that the term “diameter” has not been employed). In other embodiments, the largest dimension is not larger than 2 millimeters, and, in other embodiments, not larger than 0.5 millimeters.

The primary emulsion is added as fine droplets into a crosslinking medium in which the encapsulating agent is crosslinked, polymerized, gelled or otherwise hardened or solidified to encapsulate the M_{E}, forming beads or microcapsules, as will be described herein. Thus, it should be noted that the term “crosslinking medium” is used mainly to distinguish this medium from other liquid mediums disclosed herein, the use of “crosslinking” serving to reference the operation carried out in the medium, though such operation is not limited to crosslinking. More particularly, a method of crosslinking, polymerizing, gelling or otherwise hardening or solidifying the encapsulating agent is carried out in the “crosslinking medium,” and, although a crosslinking agent might be present in the crosslinking medium in particular embodiments, there is no absolute requirement that a crosslinking agent be present in the crosslinking medium. For example an appropriately chosen encapsulating agent might be crosslinked by ultraviolet light or heat. When a crosslinking agent is employed, it is to be understood as being an agent that serves to cause the crosslinking of the encapsulating agent. More broadly, as will be disclosed more fully below, the crosslinking of the encapsulating agent is achieved by use of an appropriate “activator.”

The encapsulating agent may also be one that gels by the lowering of temperature. For example, if gelatin or agar is used as the encapsulating agent, the droplets of primary emulsion can be added into a bath of cold water or oil to initiate the gelation and encapsulation, the cold water or oil being the crosslinking medium as broadly defined herein. Physical gelation can also be initiated by pH change. In most cases, the pH change causes the encapsulating agent to change from a charged state (more soluble in water) to a less or non-charged state (less soluble in water, more favorable for a gelled state in water). Such gelation caused by change of physical conditions is often considered as a form of “physical” crosslinking. But some will insist crosslinking is a term only applied to “chemical” crosslinking.

The crosslinking medium can either be miscible or immiscible with the continuous phase of the primary emulsion. If the crosslinking medium is miscible with the continuous phase of the primary emulsion, the primary emulsion is simply added to the crosslinking medium in the form of droplets. This may be performed by any known method, including the use of capillary jets, atomizers, sprayers and the like. The primary emulsion may simply be manually added in drops, though that is a more tedious method.

It will be appreciated that the desire is to form microencapsulated material, i.e., to encapsulate M_{E}. Thus, when the crosslinking medium is miscible with the continuous phase of the primary emulsion, the crosslinking method employed should be rapid; so as to engage crosslinking of the encapsulating agent quickly after droplets of the primary emulsion enter the crosslinking medium. This is achieved by an appropriate activator, either present in the crosslinking medium or otherwise introduced to the system.

For example, when the encapsulating agent is dissolved in the continuous phase of the primary emulsion, an appropriate activator might be in the form of a crosslinking agent that serves to promote the crosslinking of the encapsulating agent. Such an activator would be dissolved or suspended in the crosslinking medium such that, as drops of the primary emulsion contact and enter the crosslinking medium, the activator initiates rapid crosslinking of the crosslinkable compound at the interface of the continuous phase and the miscible crosslinking medium. This interface occurs as a result of the encapsulating agent being present in the continuous phase, and the rapid crosslinking prevents the continuous phase of the primary emulsion from separating and merging with the miscible crosslinking medium. As another example, the encapsulating agent might be a compound that is crosslinked through the application of ultraviolet light, and it would be possible to use ultraviolet light as the activator by exposing the crosslinking medium to ultraviolet light while the droplets of the primary emulsion are added thereto. The encapsulating agents thus serve to encapsulate the ME by being crosslinked and thereby enveloping the ME in a crosslinked matrix.

If the crosslinking medium is immiscible with the continuous phase of the primary emulsion, the primary emulsion will be added to the crosslinking medium along with an additional surfactant package that is added to facilitate dispersion of droplets of the primary emulsion, as the disperse phase, in a crosslinking medium continuous phase. This is termed herein a “seconday emulsion.” Suitable surfactants will be apparent to those of ordinary skill in the art. In this embodiment, the encapsulating agent should also be rapidly crosslinked because the secondary emulsion, which would be an oil/water/oil or water/oil/water emulsion depending upon the various liquid mediums/solvents, is not very stable. As with the embodiments employing a miscible crosslinking medium, rapid crosslinking is achieved by an appropriate activator. In this embodiment, however, the activator may be present in the crosslinking medium, present in the continuous phase of the primary emulsion, or otherwise introduced to the system.

When the activator is present in the crosslinking medium, it must be chosen such that it can diffuse or otherwise enter the continuous phase of the primary emulsion, in order that it will reach and cause crosslinking of the encapsulating agent. As with the prior embodiment employing a miscible crosslinking medium, the encapsulating agent might be a monomer or polymer that is crosslinked through the application of ultraviolet light, and it would be possible to use ultraviolet light as the activator by exposing the crosslinking medium to ultraviolet light while the droplets of the primary emulsion are added thereto.

Notably, when the activator is in the continuous phase of the primary emulsion, it must remain inert until the crosslinking of the encapsulation agent (also in the continuous phase) is desired, and, thus, an initiator is also employed in such embodiments, the initiator serving to make the activator active as opposed to inert. Thus, activators can be in the crosslinking medium, and diffuse into the continuous phase of the primary emulsion to cause crosslinking of the encapsulating agent or activators can be in the continuous phase of the primary emulsion, remaining inert until made active by an initiator, or the encapsulating agent can be crosslinked through the use of an activator otherwise introduced to the system, as for example by ultraviolet light or heat serving to crosslink an appropriate encapsulating agent (e.g., UV crosslinked or heat crosslinked encapsulating agent).

In some embodiments, after crosslinking, the M_{E} solvent and the crosslinking medium are removed to provide crosslinked beads of encapsulating material encapsulating the chosen M_{E}. The beads are washed and dried to purify them and reduce them to a useful state.

In a particular embodiment, M_{E} is sulfur, and the M_{E} solvent may be selected from virtually any solvent that dissolves sulfur. In some embodiments the ME solvent is selected from the group consisting of methylene iodide, butanol, chloroform, carbon tetrachloride, tetrahydrofuran, carbon disulfide and combinations of the above. In a particular embodiment, M_{E} is sulfur and the M_{E} solvent is carbon disulfide.

In the particular embodiment wherein M_{E} is sulfur, and the M_{E} solvent is chosen as above, the surfactant(s) of the surfactant package may be selected from the group consisting of cationic, anionic and nonionic surfactants.

Suitable cationic surfactants include dodecyltrimethylammonium bromide, dodecyltrimetylammonium chloride, cetyltrimethylammonium bromide, tetradecyltrimethylammonium bromide, lauric arginate, laurylmethyl gluceth-10 hydroxypropyldimonium chloride, benzethonium chloride, tetramethylammonium hydroxide, hexadecyltrimethylammonium bromide and hexadecyltrimethylammonium chloride.

Suitable anionic surfactants include sodium dodecyl sulfate, sodium dodecylbenzenesulfonate, ammonium dodecyl sulfate, potassium dodecyl sulfate, sodium decanoate, sodium dodecanoate, dioctyl sodium sulfosuccinate, sodium stearate, sodium pareth sulfate and sodium myreth sulfate.

Suitable nonionic surfactants include PEG-80 sorbitan laurate, Laureth-23, Ceteth-20, Oleth-20, polysorbate 20, polysorbate 80, steareth-20, steareth-21, steareth-100 and cetomacrogrol 1000. In some embodiments, nonionic surfactants are used when making the microencapsulated bead products in order to minimize the interference with the crosslinking of the alginate polymer.

In the embodiments wherein M_{E} is sulfur and the M_{E} solvent and, the surfactant package are chosen as above, the immiscible liquid medium may be selected from ethanol, methanol, acetone, water, and combinations of thereof, and the encapsulating agent may be selected from virtually any polymer that is soluble in the immiscible liquid medium chosen from the foregoing. Such encapsulating agents include but are not limited to proteins, polyethylene glycols, polyamines, chitosan, cellulose acetate with various extents of acetylation, and polysaccharides such as xantham gum, agar, agarose, gelatin, pectin, xylan, pollulan, hemicellulose and alginate and combinations thereof.

In embodiments where M_{E} is sulfur and the M_{E} solvent, the surfactant package, the immiscible liquid medium and the encapsulating agent are chosen as above, the crosslinking medium may be an aqueous solution of water and a crosslinking initiator suitable for rapidly initiating the crosslinking of the encapsulating agent at the interface between the immiscible liquid medium (i.e., the continuous phase of the primary emulsion) and the crosslinking medium. In other embodiments, the crosslinking medium may be immiscible with the continuous phase of the primary emulsion, and an appropriate surfactant package is employed to create a secondary emulsion, where the primary emulsion is dispersed in the immiscible crosslinking medium. In such an embodiment, the encapsulating agents are activator and initiators (if necessary) are chosen as directed previously hereinabove.

In a specific embodiment, the material to be encapsulated (M_{E}) is sulfur, and the M_{E} solvent is CS₂. The sulfur is dissolved in the CS₂, and this solution is added to an aqueous solution of sodium alginate in water with an appropriate surfactant package. In this particular embodiment, the surfactants of the surfactant package are sorbitan monooleate and polyoxyethylene sorbitan monooleate. Such surfactants are available commercially under the trade names Span 80 and Tween 80, respectively. The surfactant package is added to the M_{E} solution (i.e., sulfur/CS₂) and then the resultant mixture is added dropwise to the aqueous solution of sodium alginate in water with appropriate agitation to create a primary emulsion of sulfur/CS₂ droplets (disperse phase) in a sodium alginate water solution (continuous phase).

The crosslinking medium in this particular embodiment is water, and it contains a multivalent cation as the activator, which in this specific embodiment, is chosen to be calcium chloride. Thus the crosslinking medium is miscible with the continuous phase of the primary emulsion. The alginate is crosslinked as a result of the exposure to the calcium ion, which is a multivalent cation. The crosslinking of the alginate results in the creation of crosslinked calcium alginate, which physically entangles and encapsulates the CS₂ solution containing sulfur.

The crosslinking calcium chloride solution can also be modified by including other multivalent cations (e.g., ferric ions) and polymers with multiple sites of positive charges (e.g., polyethyleneimine). Using the modified crosslinking solution, the bead formation behaviors and the microcapsule properties can be improved and adjusted.

Alginate, commonly isolated from brown algae, is a linear unbranched polysaccharide with (1-4)-linked β-D-mannuronate (M) and α-L-guluronate (G) monomers. Along its polymeric chain, the monomers are organized in blocks of M, G, and M-G/G-M sequences. Alginate solutions can crosslink into hydrogels when exposed to multivalent cations. The most commonly used cation for this purpose is the calcium ion from various calcium salts such as calcium chloride, calcium lactate, calcium acetate, calcium nitrate, etc. But many other multivalent cations will be appreciated as suitable, such as iron (Fe3+ and Fe2+), barium, magnesium, aluminum, copper, cobalt, etc.

In another specific embodiment, the material to be encapsulated (M_{E}) is sulfur, and the M_{E} solvent is CS₂. The sulfur is dissolved in the CS₂, and this solution is added to an aqueous solution of sodium alginate in water with an appropriate surfactant package. In this particular embodiment, the surfactants of the surfactant package are sorbitan monooleate and polyoxyethylene sorbitan monooleate. Such surfactants are available commercially under the trade names Span 80 and Tween 80, respectively. The aqueous solution also includes calcium carbonate as an activator. The surfactant package is added to the M_{E} solution (i.e., sulfur/CS₂) and then the resultant mixture is added dropwise to the aqueous solution of sodium alginate and calcium carbonate with appropriate agitation to create a primary emulsion of sulfur/CS₂ droplets (disperse phase) in a sodium alginate/CaCO₃ water solution (continuous phase).

The crosslinking medium is immiscible with the continuous phase, and surfactant package is employed to disperse the primary emulsion in the crosslinking medium in the form of droplets. The crosslinking medium includes an acid (or an acid is added thereto) that enters the sodium alginate/CaCO₃ solution (i.e., the continuous phase of primary emulsion) and frees the calcium cation to crosslink the alginate, thus acting as an initiator.

Organic oligomers or polymers with multiple sites of positive charges such as polyethyleneimine and poly-L-lysine can be used to strengthen the crosslinking. The size of these molecules strongly affects the extents and rates of their penetration into the alginate matrix. The larger the molecules, the higher the tendency for them to form a denser crosslinked layer in the outer portion of the alginate beads. This can strengthen the beads and modify the release rate of the immobilized substances (such as sulfur).

Generally, several parameters can influence the resulting gel strength, stability, and swelling, such as alginate concentration, alginate molecular weight distribution, and M/G ratio, as well as the cation type and concentration.

The CS₂ and water are evaporated to yield finely dispersed sulfur crystals in wet alginate beads. The beads are washed with deionized water and then dried to form microcapsules. Tiny sulfur crystals are trapped and immobilized in the microcapsules. During rubber processing, the microcapsules may prevent sulfur blooming and premature crosslinking and other side reactions. At temperature higher than 115-120° C., the melted sulfur seeps out of the microcapsule matrix to effect sulfur vulcanization. If desirable, the microcapsules of sulfur can be used in processes of lower temperature where the sulfur comes out of the matrix by sublimation. The rate of sublimation decreases with decreasing temperatures. The sulfur loading and the thickness and crosslinking strength of alginate coating can also be easily modified to alter the rate of sulfur release, depending on the particular processing conditions used by individual manufacturers.

The main polymer, alginate, used for our microcapsules is a natural, non-toxic “green” product. Alginate has other advantages for use in making rubber products. For example, calcium alginate thermally degrades to compounds like calcium carbonate at temperatures near 150° C. (Kong et al., 2009) and this calcium carbonate (if high temperature vulcanization is employed) can act as non-black filler composite for certain types of rubber products. Poly(ethylene glycol) can be used as an organic lubricant and activator for mineral filled rubber compounds (Akrochem Corporation, 2006; Kim and VanderKooi, 2002), thus, serving as an alternative to other activators like the commonly used stearic acid.

In light of the foregoing, it should be appreciated that the present invention significantly advances the art by providing a simple and effective microencapsulation method that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

### EXAMPLES

### Preparation of Calcium Alginate Containing Soluble Sulfur as Core Material

Materials: Sodium alginate, deionized water, 104 rubbermakers sulfur (Harwick Standard), calcium chloride dehydrate (Sigma-Aldrich), carbon disulfide (Sigma-Aldrich), Span 80 (Sigma-Aldrich), Tween 80 (Sigma-Aldrich), mechanical stirrer, electronic digital pipette (RAININ), weighing balance, beakers, clamp, Masterflex L/S pump (Model 77200-50), Masterflex PharMed (06485-14) pump tubes, Fisher refrigerated temperature-controlled bath (Model 90), copper coil tubing, thermometer, rubber stopper, measuring cylinder, and capillary jet.

4 grams of 104 rubbermakers sulfur (CAS 7704-34-9) was dissolved into 17.8 milliliters of carbon disulfide to create an oil phase solution. 0.079 milliliters of the surfactant Span 80 and 0.172 milliliters of the surfactant Tween 80 were also added to the oil phase and mixed for 7 minutes. For the water phase, 1.212 grams of sodium alginate was dissolved into 60.6 milliliters of deionized water (2% w/v NaA1g). The oil phase was added dropwise to the water phase through the use of a pipette, and the resultant mixture was mixed together to generate an oil-in-water emulsion (30% oil phase and 70% water phase). The mixture was emulsified using a mechanical blender, mixing for 7 minutes. The surfactant package maintained an emulsion of the sulfur/CS₂ (disperse phase) in the sodium alginate/water (continuous phase). The emulsion was kept cool and controlled at a temperature of 8° C.

A solution of 6.622 grams of calcium chloride dehydrate in 200 milliliters of deionized water was created as the crosslinking medium, with mild mixing by an overhead stirrer at 150-200 rpm. The crosslinking calcium chloride solution was also kept at a temperature of 8° C. The oil-in-water emulsion was added dropwise to crosslinking medium using a capillary jet, and the calcium ion causes crosslinking of the alginate into a hydrogel. Air pressure to the capillary jet was maintained at 4 psi to make the larger beads and 5.5 psi to make smaller beads for this set of experiments. After the beads were made, they were left in the calcium chloride solution for 20 h at 8° C. The temperature was gradually increased to 30° C. and maintained at this temperature for a period of 20 h. The temperature was finally increased to 35° C. and maintained at this temperature for a period of 20 h. This was done to increase the diffusional mass transfer of carbon disulfide from the beads. Following the temperature increase, the beads were collected and washed 5 times with 350 ml of deionized water before being air dried at room temperature. The washing and drying process allows for efficient removal of the calcium disulfide and free water from the beads.

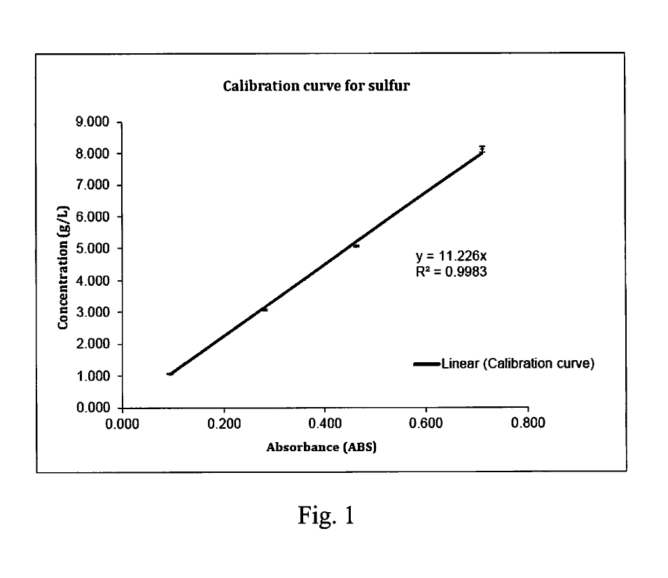

The air-dried microcapsules were measured for their sulfur content using a calibration curve for sulfur. The calibration curve was made by making different concentrations of sulfur in carbon disulfide and measuring absorbance (ABS) at a wavelength of 382 nm. The measurements were done three different times to see if there was any significant deviation in the calibration curve. The sulfur calibration curve can be seen in FIG. 1. FIG. 1 shows that there was no significant difference between the three sets of calibrations that were done. The calibration curve was used to calculate the weight percent of sulfur from the microencapsulated soluble sulfur beads. There were different steps taken for measuring the weight percent of sulfur using UV-Vis spectroscopy analysis. The first step was to measure the weight of the grounded microencapsulated soluble sulfur beads. The second step was to dissolve the grounded beads in a known volume of CS2 while the third step was to filter the components from the second step. The liquid filtrate was placed in a quartz cuvette and then measured using a UV-Vis spectrophotometer at a wavelength of 382 nm. The absorbance from the UV-Vis spectrophotometer was converted to sulfur concentration, which was then used to calculate the sulfur content (%) in the original beads.

For example, the above steps were used to calculate a weight percent of sulfur for beads that were prepared by a 30% oil/70% water emulsion system. The weight of the grounded beads measured 0.0418 g which was dissolved in 10 ml of CS2 (4.18 g/l). This grounded sample was filtered using a Popper & Sons Micro-Mate interchangeable 5 cc syringe with a 0.2 μm Fisherbrand polytetrafluoroethylene (PTFE) filter attached to it. After the grounded sample was filtered, it was measured in the UV-Vis spectrophotometer at 382 nm to give an absorbance of 0.318 ABS. Using this absorbance, and the sulfur calibration curve, a concentration of sulfur in CS2 was obtained (3.56 g/l). By comparing this concentration (3.56 g/l), with the initial concentration (4.18 g/l), an 85.2% of sulfur was achieved. This weight percentage was for a batch of smaller beads.

Another example was for larger beads made in another batch of microencapsulation. The weight of the larger grounded beads used was 0.0434 g. The grounded beads were mixed in 10 ml of CS2 (4.34 g/l). This sample was filtered the same way and the UV-Vis measurement was done similarly to get an absorbance of 0.339 ABS. A concentration of 3.81 g/l was obtained which corresponds to 87.7% of sulfur by weight in the beads.

Sulfur Encapsulation with Alginate and Polymer Addition

4 grams of 104 rubbermakers sulfur (CAS 7704-34-9) was dissolved into 17.8 milliliters of carbon disulfide to create an oil phase solution. 0.079 milliliters of the surfactant Span 80 and 0.172 milliliters of the surfactant Tween 80 are also added to the oil phase. For the water phase, 0.62 grams of sodium alginate is dissolved into 62 milliliters of deionized water. The oil phase is added dropwise to the water phase through the use of a pipette and the resultant mixture is mixed together to generate an oil-in-water emulsion. The mixture was emulsified using a mechanical blender, and took approximately seven minutes. The surfactant package maintains an emulsion of the sulfur/CS₂ (disperse phase) in the sodium alginate/water (continuous phase).

This oil-in-water emulsion is added dropwise to a solution of 6.622 grams of calcium chloride dehydrate in 200 milliliters of deionized water and 16 milliliters of 50 weight percent solution of polyethyleneimine in water with mild mixing by an overhead stirrer at 150-200 rpm. The calcium ion causes crosslinking of the alginate into a hydrogel. After allowing crosslinking to proceed for twenty hours, the water and CS₂ was evaporated and the crosslinked beads were washed five times with 350 milliliters of deionized water before being air dried at room temperature. The washing and drying process allows for efficient removal of the calcium disulfide and free water from the beads.

What is claimed is:

1. A method for encapsulating a material comprising the steps of:
a. choosing a material to encapsulate,
b. placing the material into a material solvent to form a material solution,
c. forming a primary emulsion of the material solution in an immiscible liquid medium that is immiscible with the material solvent, the material solution serving as the disperse phase and the immiscible liquid medium serving as the continuous phase of the primary emulsion, wherein the immiscible liquid medium contains an encapsulating agent dissolved therein, the encapsulating agent being capable of being crosslinked, polymerized, gelled or otherwise hardened or solidified;
d. adding the primary emulsion as droplets into a crosslinking medium, wherein the crosslinking medium is immiscible with the continuous phase immiscible liquid medium of the primary emulsion, and thereafter
e. activating the crosslinking, polymerizing, gelling, hardening or solidifying of the encapsulating agent to envelope the material in a crosslinked, polymerized, gelled or otherwise hardened or solidified matrix forming the droplets into beads.

2. The method of claim 1, wherein the primary emulsion is emulsified in said crosslinking medium to create a secondary emulsion.

3. The method of claim 1, wherein the crosslinking medium includes an activator that, upon contact with the encapsulating agent, causes the crosslinking, polymerizing, gelling or otherwise hardening or solidifying of the encapsulating agent, and wherein said step of activating includes contact between the activator and the encapsulating agent.

4. The method of claim 1, wherein the encapsulating agent is capable of being crosslinked, polymerized, gelled or otherwise hardened or solidified by ultraviolet light, and said step of activating includes applying ultraviolet light to the crosslinking medium during or after said step of adding the primary emulsion as droplets into the crosslinking medium.

5. The method of claim 1, wherein the encapsulating agent is capable of being crosslinked, polymerized, gelled or otherwise hardened or solidified by heat, and said step of activating includes applying heat to the crosslinking medium during or after said step of adding the primary emulsion as droplets into the crosslinking medium.

6. The method of claim 1, wherein the continuous phase immiscible liquid medium of the primary emulsion includes an activator for activating the crosslinking, polymerizing, gelling or otherwise hardening or solidifying of the encapsulating agent, said activator remaining inert until made active during said step of activating by the use of an initiator.

7. The method of claim 1, wherein said material to encapsulate is sulfur.

8. The method of claim 7 in which the solvent is carbon disulfide.

9. The method of claim 8 in which the immiscible liquid medium is water.

10. The method of claim 9 in which the immiscible liquid medium further contains a surfactant package and wherein the surfactant package contains sorbitan monooleate and polyoxyethylene sorbitan monooleate.

11. The method of claim 10 in which the encapsulating agent is alginate.

12. The method of claim 11 in which the crosslinking medium is water and includes a multivalent cation selected from the group consisting of calcium, iron (Fe3+ and Fe2+), barium, magnesium, aluminum, copper, and cobalt.
